(19) United States
(12) Patent Application Publication
(10) Pub. No.: US 2005/0099448 A1
(43) Pub. Date: May 12, 2005

(54) Methods and apparatus for selecting image enhancement techniques

(76) Inventors: Eugene A. Roylance, Boise, ID (US); Shell S. Simpson, Boise, ID (US)

Correspondence Address: HEWLETT-PACKARD COMPANY;Intellectual Property Administration, P.O. Box 272400, Fort Collins, CO, 80527-2400, US

(21) Appl. No.: 11/008,347

(22) Filed: Dec. 8, 2004

Related U.S. Application Data
(63) Continuation of application No. 10/626,360, filed on Jul. 23, 2003.

(51) Int. Cl. G06K 1/00

(52) U.S. Cl. 347/19

(57) ABSTRACT

Memory integrated into a removable cartridge for an image forming device is programmed with image enhancement data. The image enhancement data includes a condition associated with data identifying an image enhancement technique and a parameter for implementing the image enhancement technique.

### CROSS REFERENCE TO RELATED APPLICATION

This application is a continuation of U.S. application Ser. No. 10/626,360 filed Jul. 23, 2003.

### BACKGROUND

Image forming devices such as laser printers, copy machines, and facsimile machines employ electro photographic processes to produce printed images on paper or other print media. In laser printers, a source image is rasterized to form a bitmap image for subsequent rendering to a final printed image. A source image can include a number of elements. Examples include text, vector, and/or continuous tone or graphic elements such as a photo. When a source image is rasterized creating a bitmap image, the various elements are converted to pixel patterns that approximate the source image.

Once a bitmap image is generated from a source image, it can be printed by modulating and scanning a laser beam across a charged surface of a photoconductive drum in a succession of scan lines. Each scan line is divided into pixel areas, and the modulated laser beam causes some pixel areas to be exposed to a light pulse and some not. Where a pixel area is illuminated, the photosensitive drum is discharged so that, when it is subsequently toned, the toner adheres to the discharged areas and is repelled by the still charged areas. The toner adhering to the discharged areas is then transferred and fixed to paper or other print media.

Because of its digital nature, a printed bitmap image does not perfectly reflect the source image. For example, printed image edges that are either not parallel or not perpendicular to the scan direction of the laser can appear stepped or jagged. This is especially noted in text and line art. Because resolution is also limited, a bitmap representation of a graphical element such as a photo can appear degraded.

Various image enhancement techniques have been developed to improve the quality of a printed bitmap image. Among many others, these enhancement techniques include: edge smoothing, fine line broadening, anti-aliasing, and resolution doubling. In a laser printer, for example, one or more techniques can, when implemented, modulate the laser to produce a pixel smaller than a standard pixel size. The techniques may also indicate that the laser output is to be offset from the pixel center. Parameters for a particular image enhancement technique can dictate pixel size and offset position.

In addition to improving the quality of printed images, printer manufacturers are also faced with reducing the cost associated with printing those images. One of the more significant operation costs of a laser printer is that of imaging material such as toner or ink. Recognizing this, various imaging enhancement techniques have been developed to conserve imaging material.

For a given image forming device, developing criteria for selecting among a variety of available image enhancement techniques and for selecting optimal parameters for implementing those techniques is a complex process. Numerous factors must be taken into account. Some of these factors include:
an identification of the particular image or particular portion of that image being printed—for example—an identification of a text pixel or halftone graphics pixel;
device wear and its impact on print quality;
environmental conditions and their impact on print quality; and
variations between individual printers and printer components such as cartridges and the impact those variations can have on print quality.

Because there are so many complex factors involved in developing criteria for selecting image enhancement techniques, the introduction of a new image forming device to consumers can be significantly delayed. To decrease delays, one possible solution involves using image enhancement techniques, parameters, and selection criteria (collectively and individually referred to as image enhancement data) previously developed for a similar but older device design when first introducing a new design to consumers. The older image enhancement data will not be optimal for the new design. However, image enhancement data, once developed for the new design, can be deployed later as an upgrade.

As with the deployment of other upgrades, deploying new image enhancement data for use by image forming devices already sold and in use can lead to a number of logistical problems. The consumer is usually responsible for implementing the upgrade. The consumer must first learn of the upgrade and then take steps required to install the upgrade—whether that be installing new programming or new hardware. Consumers who are not aware of an upgrade will not benefit. Consumers who learn of an upgrade but are not sophisticated enough to implement it also will not benefit. If acquiring or installing installation proves to be difficult or time consuming, those consumer's who choose to take time to implement an upgrade can be seriously inconvenienced.

### DESCRIPTION OF THE DRAWINGS

FIG. 1 is a schematic representation of the physical and logical components of an exemplary image forming device according to an embodiment of the present invention.

FIG. 2 is a schematic representation of exemplary cartridge and device printing components of FIG. 1 according to an embodiment of the present invention.

FIG. 3 is a schematic representation of exemplary cartridge and device printing components of FIG. 1 according to another embodiment of the present invention.

FIGS. 4A and 4B schematically illustrate the contents of cartridge memory and device memory according to an embodiment of the present invention.

FIGS. 5A and 5B schematically illustrate the contents of cartridge memory and device memory according to another embodiment of the present invention.

FIG. 5C illustrates an exemplary implementation of technique selection logic in the form of a look-up table according to an embodiment of the present invention.

FIG. 6 is an exemplary flow diagram illustrating steps taken to print according to an embodiment of the present invention.

FIG. 7 is an exemplary flow diagram illustrating steps taken to print according to another embodiment of the present invention.

### DETAILED DESCRIPTION

INTRODUCTION: An image forming device can use a variety of image enhancement techniques to improve the quality of printed output and to reduce the amount of imaging material required to produce the printed output. The particular technique or techniques used at a given time as well as the parameters for implementing those techniques depend upon a number of complex factors. In the description that follows image enhancement techniques, parameters for implementing image enhancement techniques, and selection criteria are at time referred to individually and collectively as image enhancement data. Consequently, developing image enhancement data that is optimal for a given image forming device is a difficult and time consuming task. To avoid delaying the introduction of a new image forming device to the market, it is often beneficial initially to initially use image enhancement data previously developed for a similar but older design. Once image enhancement data is developed specifically for the new design, it can be released as an upgrade.

Many image forming devices such as laser and ink printers use replaceable cartridges. The cartridges contain imaging material such as toner or ink as well as components for dispensing the imaging material. As the imaging material is depleted, the cartridge is removed and replaced. To maintain a supply of imaging material, consumers expect to periodically remove and replace cartridges. Memory integrated into a cartridge can be programmed to supply newly developed image enhancement data. Once the cartridge is installed, the memory can be accessed and read and the image forming device upgraded to use the new image enhancement data.

In addition to supplying upgrades, integrating image enhancement data within a printer cartridge allows a manufacturer to more efficiently capitalize on the subjective preferences of a demographic. Different cartridge models for the same printer can be developed with image enhancement data designed specifically for a given demographic. For example, certain groups of people prefer printed text to appear thicker and bolder. Others prefer finer lines. For a given printer, one cartridge model can be produced with image enhancement data that causes printed text to appear thicker and bolder, and another cartridge model can be produced with image enhancement data that causes printed text to appear relatively fine. Each cartridge model can then be marketed to its intended demographic.

TERMINOLOGY: The terms image forming device, image enhancement techniques, parameters, and selection criteria are used throughout the following description. An image forming device is any device that can produce a printed image on paper or any other print media. Examples include, ink printers, laser printers, facsimile machines, copiers, and all-in-one or multi-function printers. Image enhancement techniques include any techniques that can improve the quality of printed output as well as any techniques that can reduce the amount of imaging material such as toner or ink toner used to produce the printed output. A parameter is data used to implement an image enhancement technique.

Selection criteria are criteria used to determine which image enhancement technique or techniques to use at a given time and/or to determine a parameter or parameters for implementing the particular image enhancement technique or techniques. The determinations can be based upon any number of factors including, but not limited to, whether an image includes text, graphics, or both, the environment in which the image forming device is operating, the level of remaining imaging material, and the extent to which the limited life components of the image forming device have been used. Limited life components are those components of an image forming device that degrade or wear though use affecting print quality. Often, limited life components are integrated within the same cartridge containing the imaging material.

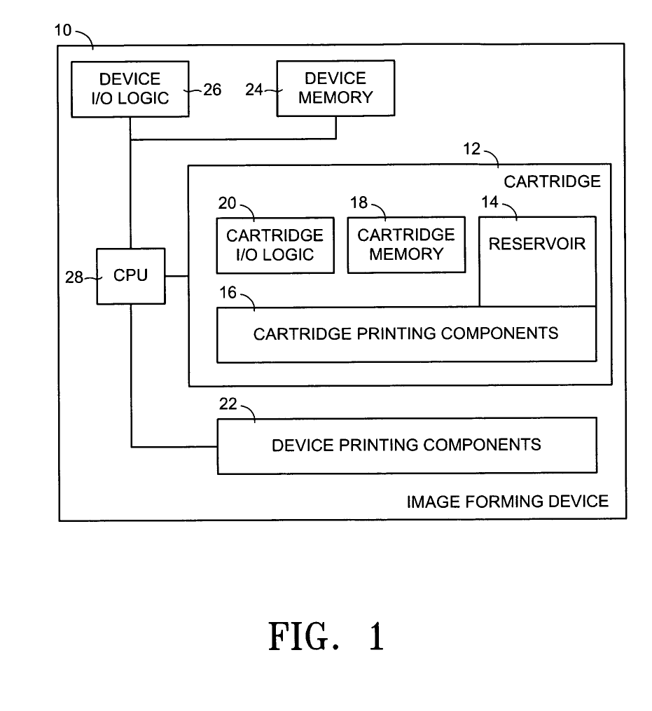

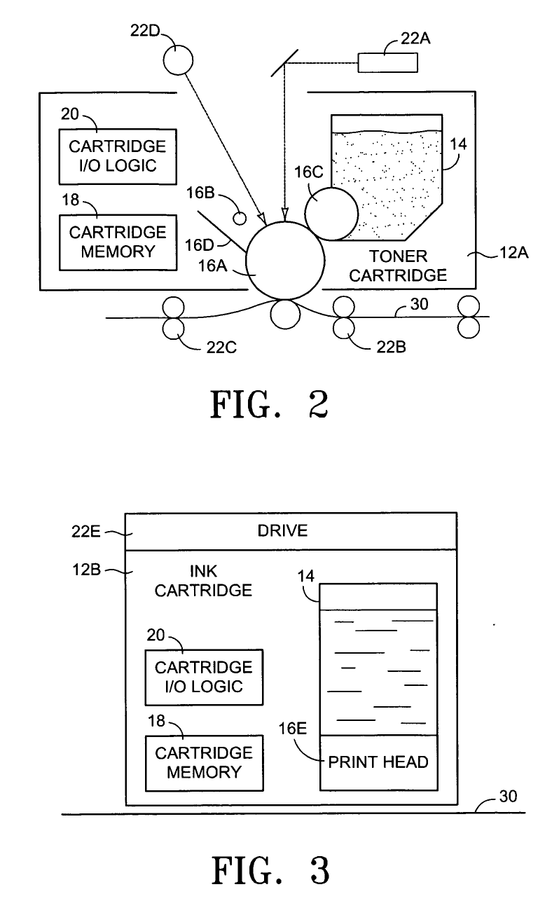

COMPONENTS: The physical and logical components of various embodiments of the invention will now be described with reference to the block diagrams of FIGS. 1-5. FIG. 1 schematically depicts an exemplary image forming device referenced as image forming device 10 with an exemplary cartridge referenced as cartridge 12. Cartridge 12 represents generally any apparatus supplying one or more components needed by image forming device 10 to produce a printed image. Preferably, cartridge 12 can be easily removed from image forming device 10 and replaced. Cartridge 12 can then provide imaging material and one or more limited life components. When cartridge 12 reaches the end of its useful life, it can be replaced so that image forming device 10 can continue to be used. More detailed examples of cartridge 12 are described below with reference to FIGS. 2 and 3.

As shown in FIG. 1, cartridge 12 includes reservoir 14, cartridge printing components 16, cartridge memory 18, and cartridge I/O (Input/Output) 20. Reservoir 14 represents generally any compartment for holding and dispensing a consumable such as ink or toner. Cartridge printing components 16 represent hardware capable of being used to help produce a printed image using a consumable held in reservoir 14. Cartridge printing components 16 can be limited life components. Cartridge memory 18 represents generally any single memory device or combination of memory devices. Cartridge memory 18 can be or include a rewritable, persistent storage apparatus, including flash memory, EEPROM, battery backed RAM, magnetic media, and optical magnetic media. Cartridge I/O 20 represents any hardware and/or programming that enables communication with memory 18.

Image forming device 10 also includes device printing components 22, device memory 24, device I/O logic 26, and CPU (Central Processing Unit) 28. Device printing components 22, when used in conjunction with cartridge printing components 16, represent hardware capable of dispensing a consumable from reservoir 14 onto print media in the form of a desired print image. The printed image can include any combination of text and/or graphics. Device memory 24 represents any memory device or combination of memory devices that can store programming and other data used to guide cartridge and device printing components 16 and 22 in the production of a printed image. Device logic 26 represents generally any programming that enables programming stored in device memory 24 to communicate with cartridge 12 and access cartridge memory 18. Device logic 26 is responsible for both reading data from and writing data to cartridge memory 18. CPU 28 represents any processor capable of executing instructions from programming stored in device memory 24 and cartridge memory 18. At least some of the executed instructions guide cartridge and device printing components 16 and 22 to form a desired image on print media.

FIGS. 2 and 3 illustrate two exemplary cartridge types. In FIG. 2, cartridge 12 is a toner cartridge 12A. In FIG. 3, cartridge 12 is an ink cartridge 12B. In the example of FIG. 2, cartridge printing components 16 include photoconductive drum 16A, charging device 16B, developer 16C, and wiper 16D. FIG. 2, also shows device printing components 22 which include laser 22A, charge rollers 22B, fuser rollers 22C, and discharge lamp 22D.

In operation, charging device 16B places a uniform electrostatic charge on photoconductive drum 16A. Light from laser 22A is scanned across photoconductive drum 16A in a pattern of a desired print image. Where exposed to the light, photoconductive drum 16A is discharged creating an electrostatic version of the desired print image. Developer 16 transfers charged toner particles from toner reservoir 14A to photoconductive drum 16A. The charged toner particles are repelled by the charged portions of photoconductive drum 16A but adhere to the discharged portions. Charge roller 22B charges or discharges media sheet 30. As media sheet passes across photoconductive drum 16A, toner particles are then transferred from photoconductive drum 16A to media sheet 30. Fuser rollers, thermally fix the transferred toner particles to media sheet 30. Discharge lamp 22D removes the remaining charge on photoconductive drum 16A, and wiper 16D removes any residual toner particles remaining on photoconductive drum 16A.

In the example of FIG. 3, cartridge printing components 16 of ink cartridge 12B includes print head 16E. Device printing components 22 include drive 22E. In operation, print head 16E selectively ejects ink from reservoir 14 onto media sheet 30 according to a desired print image. Drive 22E selectively moves and positions the print head 16E relative to media sheet 30 such that the ejected ink forms the desired print image.

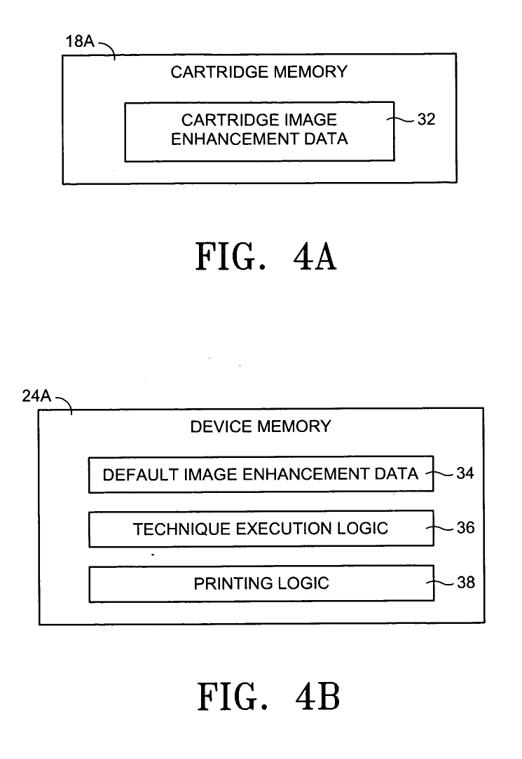

Referring now to FIGS. 4A and 4B, cartridge memory 18A is formatted to contain cartridge image enhancement data 32. Referring to FIG. 4B, device memory 24A includes default image enhancement data 34, technique execution logic 36, and printing logic 38. Cartridge and default image enhancement data 32 and 34 each represent generally any data used for image enhancement. More specifically, image enhancement data 32 and 34 can include image enhancement techniques, parameters, and/or selection criteria for selecting an image enhancement technique or for selecting from among image enhancement techniques. The term default indicates only that image enhancement data 34 is not stored in cartridge memory 18. Cartridge image enhancement data 32 may be identical to or different than default image enhancement data 34. The phrase “selecting an image enhancement technique” can mean selecting a particular image enhancement technique or selecting parameters for implementing an image enhancement technique. The phrase “selecting from among image enhancement techniques” can mean selecting a particular image enhancement technique from a plurality of techniques or selecting a parameter or parameters from a plurality of parameters for implementing an image enhancement technique.

As an example, image enhancement data 32 and 34 may each include one or more conditions each associated with electronic data identifying one or more image enhancement techniques and/or parameters, if any, for implementing image enhancement techniques. A condition is a circumstance or set of circumstances that when met indicate the image enhancement technique(s) and any parameter(s) associated with that condition are to be implemented. The following are examples of conditions and associated techniques.
A condition may be met upon determining that text or line art is being printed. That condition could be associated with an image enhancement technique for edge smoothing.
A condition may be met upon determining that a halftone image is being printed. That condition could be associated with an image enhancement technique for improving halftone images.

A condition may be met upon determining that a solid area is being printed. That condition could be associated with an image enhancement technique for conserving imaging material.

Technique execution logic 36 represents any programming capable of implementing an image enhancement technique. Technique execution logic 56 may perform this function by determining if cartridge image enhancement data 32 is present and enhancing an image by implementing techniques according to parameters, if any, identified by cartridge image enhancement data 32. If cartridge image enhancement data 32 is not present, technique execution logic 36 may implement techniques according to parameters, if any, identified by default image enhancement data 34. It is noted that the techniques implemented and/or the parameters may be identified by cartridge image enhancement data 32 and default image enhancement data 34. In one embodiment, default image enhancement data 34 may not be present. In such a case, technique execution logic 36 may determine that cartridge image enhancement data 32 is also not present and disable all image enhancement capabilities. In another embodiment, technique execution logic 36 can simultaneously execute image enhancement data 32 and 34.

For example, when executing image enhancement data 32 and/or 34, technique execution logic 36 determines when a condition contained in image enhancement data 32 or 34 is met, and then implements the image enhancement technique(s) according to parameter(s), if any, associated with that condition. It may be determined that more than one condition has been met at a given time. Technique execution logic 36, depending on which condition is met, can digitally enhance a rasterized image before it is printed and it can enhance a printed image in real time by affecting the operation of printing components 16 and/or 22 as the image is being printed. Preferably, real time aspects of technique execution logic 36, such as those that directly affect the modulation and deflection of laser 22A (FIG. 2), are performed using circuit level logic such as an ASIC (Application Specific Integrated Circuit).

Printing logic 38 represents generally any programming capable of controlling the production of a printed page. Printing logic 38 is responsible for using technique execution logic 36 to execute image enhancement data 32 and/or 34 and for using cartridge and device printing components 16 and 22 to generate printed output.

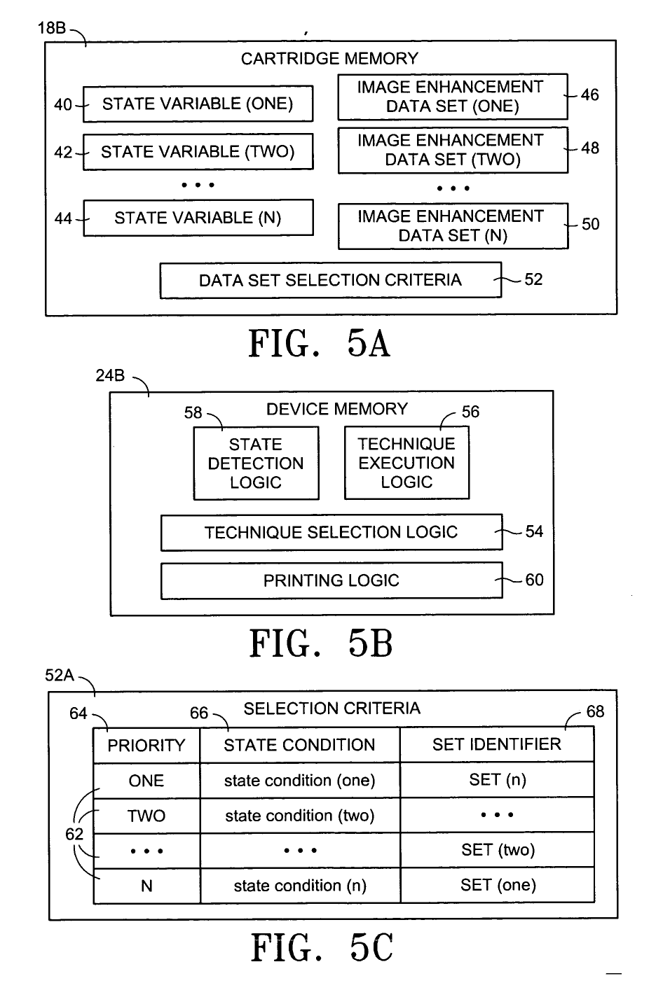

FIGS. 5A and 5B help to illustrate another configuration and implementation of cartridge memory 18 and device memory 24. Referring first to FIG. 5A, cartridge memory 18B includes state variables 40-44, image enhancement data sets 46-50, and data set selection criteria 52. State variables 40-44 are generally a collection of variables used to assist in selecting from among image enhancement data sets 46-50. State variables 40-44 are periodically updated so that different image enhancement data sets 46-50 are selected at different times over the life of cartridge 12 and more specifically over the limited life of cartridge printing components 16. In one embodiment, state variables 40-44 are variables that in some manner reflect the age or wear of cartridge printing components 16 and/or device printing components 22. With reference to FIG. 2, a given state variable 40 may represent the amount of toner remaining in reservoir 14. Another state variable 42 may represent the duration that photoconductor drum 16A has been exposed to laser 22A and/or discharge lamp 22D. Another state variable 44 may reflect the number of pages printed using cartridge 12.

Image enhancement data sets 46-50, each represent generally any data used for image enhancement. More specifically, each image enhancement data set 46-50 can include image enhancement techniques, parameters, and/or selection criteria for selecting an image enhancement technique or for selecting from among image enhancement techniques. The term “set” is used only to help the reader distinguish one group of image enhancement data from another. Again, it is noted that The phrase “selecting an image enhancement technique” can mean selecting a particular image enhancement technique or selecting parameters for implementing an image enhancement technique. The phrase “selecting from among image enhancement techniques” can mean selecting a particular image enhancement technique from a plurality of techniques or selecting a parameter or parameters from a plurality of parameters for implementing an image enhancement technique.

Image enhancement data set 46, for example, may identify all available image enhancement techniques and/or parameters most demanding on cartridge printing components 16. Image enhancement data set 48 may identify all available image enhancement techniques and/or parameters less demanding on cartridge printing components 16. Image enhancement data set 50 may not identify all available image enhancement techniques. For those it does identify, it may specify parameters that are least demanding on cartridge printing components 16.

Data set selection criteria 52 represents electronic data that can be processed with one or more state variables 40-44 to select from among image enhancement data sets 46-50. As the values of state variables 40-44 change, processing data set selection criteria 52 will result in a different image enhancement data 46, 48, or 50 being selected.

Referring to FIG. 5B, device memory 24 contains technique selection logic 54, technique execution logic 56, state monitor 58, and printing logic 60. Technique selection logic 54 represents generally any programming capable of processing data set selection criteria 52 to select image enhancement data set 46, 48, or 50. Using the example above, where state variables 40-44 indicate that cartridge 12 is new or has been minimally used, data set selection criteria 52 will indicate that image enhancement data 46 is to be selected. Where state variables 40-44 reveal that cartridge 12 is beginning to wear and that wear affects the operation of cartridge 12, data set selection criteria 52 will indicate that image enhancement data 48 is to be selected. Finally, where state variables 40-44 reveal that cartridge 12 is well worn with minimal useful life remaining, data set selection criteria 52 will indicate that image enhancement data 50 is to be selected.

Technique execution logic 56, as defined above, represents generally any programming capable of implementing an image enhancement technique. Technique execution logic 56 may perform this function by implementing techniques according to parameters, if any, identified by image enhancement data sets 46-50. It is noted that the techniques implement and/or the parameters may be identified by image enhancement data sets 46-50.

State monitor 58 represents generally any combination of hardware and/or programming capable of monitoring the state of cartridge printing components 16 and/or device printing components 22 and updating state variables 40-44 accordingly. With reference to FIG. 2, state monitor 58 may be capable of identifying the amount of toner remaining in reservoir 14 and updating state variable 40 to reflect the identified amount. State monitor 58 may be able to update state variable 4044 to reflect the duration that photoconductor drum 16A has been exposed to laser 22A and/or discharge lamp 22D. State monitor 58 may be able to update state variable 40-44 to reflect the number of pages printed during the life of cartridge printing components 16.

Printing logic 60 represents generally any programming capable of controlling the production of a printed page. Printing logic 50 is responsible for using technique selection logic 54 to select image enhancement data set 46, 48, or 50, using technique execution logic 56 to execute the selected image enhancement data set 46, 48, or 50, and using cartridge and device printing components 16 and 22 to generate printed output.

FIG. 5C illustrates an example of data set selection criteria 52 implemented in look-up table 52A. Lookup table 52A includes entries 62 to be processed by technique selection logic 56 to select image enhancement data set 46, 48, or 50. Each entry 62 includes data in a priority field 64, in a state condition field 66, and in a set identifier field 68. The data in priority fields 64 of entries 62 dictate the order in which entries 62 are to be processed. The data in each state condition field 66 sets a condition relating to the current value or values of one or more state variables 40-44. The data in each set identifier field 68 identifies a particular image enhancement data set 46, 48, or 50.

To select image enhancement data set 46, 48, or 50, technique selection logic 56 processes entries 62 in a hierarchical order dictated by priority field 64 data of entries 62. When processing a given entry 62, technique selection logic 54 determines if a condition required by data in state condition field 66 for that entry 62 is being met. If that condition is being met, technique selection logic 54 selects mage enhancement data set 46, 48, or 50 identified by data in set identifier field 68 for that entry 62. Technique selection logic 54 then stops processing further entries 62. If the condition is not being met, technique selection logic 54 continues processing subsequent entries 62 in an order dictated by priority field 64 data. One image enhancement data set 46, 48, or 50 may be identified as a default to be selected if none of the conditions required by data in state condition field 66 for all entries 62.

State variables 4044 and data set selection criteria 52 could instead be stored in device memory 24B. Preferably, state variables 40-44 are stored in cartridge memory 18B. If cartridge 12 is removed from image forming device 10 and inserted into a different image forming device (not shown) then state variables 40-44 remain with cartridge 12. Where state variables 4044 are maintained in device memory 24, they do not follow cartridge 12 when it is removed and used elsewhere. Technique selection logic 54 may be stored in cartridge memory 18 and then loaded into device memory 24 to be utilized by printing logic 60 as needed. Similarly, image enhancement data sets 46-50, while stored in cartridge memory 18, may also be loaded into device memory 24 to be utilized by technique selection logic 54 and technique execution logic 56.

The block diagrams of FIGS. 1-5 show the architecture, functionality, and operation of various implementations of the present invention. Each block may represent in whole or in part a module, segment, or portion of code that comprises one or more executable instructions to implement the specified logical function(s). Each block may represent a circuit or a number of interconnected circuits to implement the specified logical function(s).

Also, the present invention can be embodied in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, infrared, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

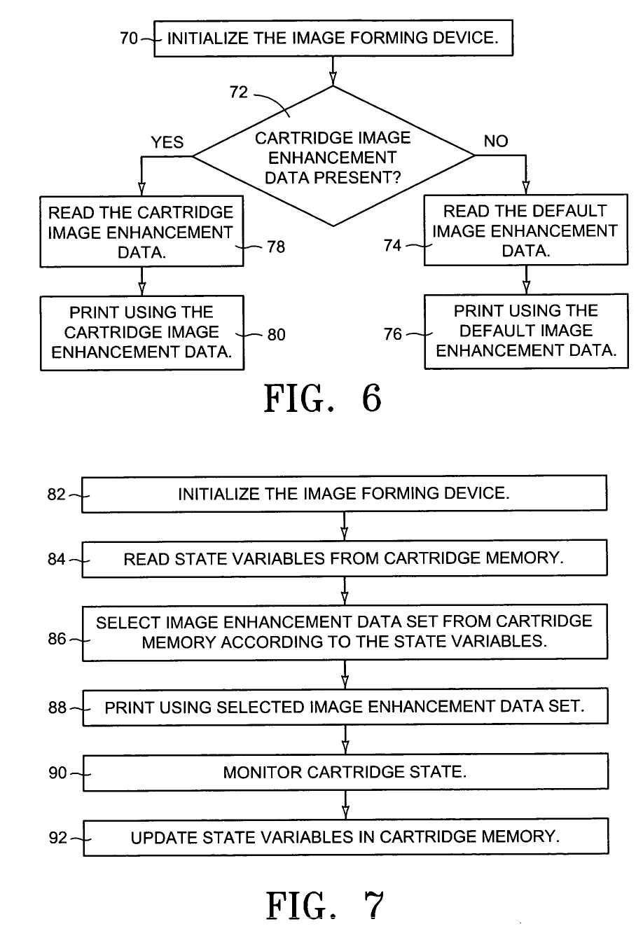

OPERATION: The operation of embodiments of the present invention will now be described with reference to the flow diagrams of FIGS. 6 and 7. FIG. 6, with reference to FIGS. 4A and 4B, illustrates steps taken to print an image using image enhancement techniques identified by default image enhancement data 34 and cartridge image enhancement data 32. FIG. 7, with reference to FIGS. 5A-5C, illustrates steps taken to print an image using image enhancement data set 46, 48, or 50 selected according to state variables 40-44.

Referring first to FIG. 6, image forming device 10 is initialized (step 70). Initializing may involve turning on or resetting image forming device 10, or it may involve sending or receiving a print job. Where image forming device 10 is a laser or ink printer, initializing may involve receiving a print job from a word processor running on a connected computer. Where image forming device 10 is a copier, initializing may involve receiving instructions to print a scanned document. It is then determined if a cartridge image enhancement data is present (step 72). If not present, a default image enhancement data is read (step 74). A print job or jobs are then printed using the default image enhancement data (step 76). If in step 72 it is determined that a cartridge image enhancement data is present, the cartridge image enhancement data is read (step 78) and a print job or jobs are then printed using the cartridge image enhancement data (step 76).

With reference to FIGS. 4A and 4B, step 72 and step 74 or 78 may be accomplished by technique execution logic 36. Printing logic 38 then, using technique execution logic 36 to execute default image enhancement data 34 or cartridge image enhancement data 32, directs the production of a print job in step 76 or in step 80.

Referring now to FIG. 7, image forming device 10 is initialized (step 82). State variables are read (step 84), and an image enhancement data set is selected (step 86). With reference to FIGS. 5A-5C, steps 84 and 86 may be accomplished by technique selection logic 44 processing data set selection criteria 52. In completing step 86, technique selection logic 54 processes data set selection criteria 52 using the current values of state variable 40-44 to select image enhancement data set 46, 48, or 50.

A print job or jobs are then printed using the selected image enhancement data set (step 88). Referring back to FIGS. 5A-5C, printing logic 60 directs cartridge and device printing components 16 and 22 to produce a printed image while directing technique execution logic 56 to enhance the printed image by implementing image enhancement data set 46, 48, or 50 selected in step 86.

The state of cartridge 12 is monitored (step 90). For example, step 90 can involve identifying a toner or ink level. It can involve measuring the use of cartridge printing components 16 such as the duration to which photoconductive drum 16A has been exposed to laser 22A as well as the number pf printed pages. State variables 40-44 are updated accordingly (step 92).

Although the flow chart of FIGS. 6 and 7 show specific orders of execution, the orders of execution may differ from that which is depicted. For example, the order of execution of two or more blocks may be scrambled relative to the order shown. Also, two or more blocks shown in succession may be executed concurrently or with partial concurrence. All such variations are within the scope of the present invention.

CONCLUSION: The present invention has been shown and described with reference to the foregoing exemplary embodiments. It is to be understood, however, that other forms, details, and embodiments may be made without departing from the spirit and scope of the invention which is defined in the following claims.

1. A computer readable medium integrated into a removable cartridge for an image forming device, the medium being programmed with image enhancement data that includes a condition associated with data identifying an image enhancement technique and a parameter for implementing the image enhancement technique.

2. A removable cartridge for an image forming device, comprising:
a printing component that can be utilized by the image forming device to assist in producing a printed image; and
a memory programmed with image enhancement data that includes a condition associated data identifying an image enhancement technique and a parameter for implementing the image enhancement technique.

3. The removable cartridge of claim 2, further comprising a reservoir for holding imaging material, and wherein the printing component can be utilized by the image forming device to assist in producing a printed image using imaging material from the reservoir.

4. An image enhancement method, comprising:
reading image enhancement data from a memory integrated into a removable cartridge for an image forming device, the image enhancement data including a condition associated with a parameter for implementing an image enhancement technique; and
implementing the image enhancement technique upon a determination that the condition has been met.

5. The method of claim 4, wherein the condition is associated with data identifying an image enhancement technique and the parameter for implementing the image enhancement technique, and wherein implementing comprises implementing the image enhancement technique according to the parameter upon a determination that the condition has been met.

6. The method of claim 4, further comprising determining if image enhancement data is present in the memory integrated into the removable cartridge and, if not, reading a default image enhancement data and implementing an image enhancement technique identified by the default image enhancement data.

7. A computer readable medium having instructions for:
reading image enhancement data from a memory integrated into a removable cartridge for an image forming device, the image enhancement data including a condition associated with a parameter for implementing an image enhancement technique; and
implementing the image enhancement technique upon a determination that the condition has been met.

8. The medium of claim 7, wherein the condition is associated with data identifying an image enhancement technique and the parameter for implementing the image enhancement technique, and wherein the instructions for implementing include instructions for implementing the image enhancement technique according to the parameter upon a determination that the condition has been met.

9. The medium of claim 7, having further instructions for determining if image enhancement data is present in the memory integrated into the removable cartridge and, if not, reading a default image enhancement data and implementing an image enhancement technique identified by the default image enhancement data.

10. An image enhancement system for an image forming device, comprising default image enhancement data, and template execution logic capable of determining if cartridge image enhancement data is present and implementing the cartridge image enhancement data, otherwise implementing the default image enhancement data.

11. An image enhancement system for an image forming device, comprising:
technique selection logic capable of selecting an image enhancement data set from a plurality of image enhancement data sets contained in a memory integrated into a removable cartridge for the image forming device; and
technique execution logic capable of implementing an image enhancement technique identified by the selected image enhancement data set.

12. The system of claim 11, wherein the technique execution logic is capable of implementing an image enhancement technique according to parameters identified by the selected image enhancement data set.

13. The system of claim 11, wherein the technique selection logic is capable of obtaining a state variable reflecting a state of a printing component and selecting an image enhancement data set according to the state variable.

14. The system of claim 11, wherein the technique selection logic is capable of processing data set selection criteria to select the image enhancement data set from among the plurality of image enhancement data sets.

15. The system of claim 14, wherein the technique selection logic is capable of obtaining a state variable reflecting a state of a printing component and processing data set selection criteria with the state variable to select the image enhancement data set from among the plurality of image enhancement data sets.

16. The system of claim 11, wherein the selected image enhancement data set includes a condition associated with data identifying the image enhancement technique, and wherein the technique execution logic is capable of determining if the condition has been met and implementing the image enhancement technique only if the condition has been met.

17. The system of claim 11, wherein the selected image enhancement data set includes a condition associated with parameters for implementing the image enhancement technique, and wherein the technique execution logic is capable of determining if the condition has been met and implementing the image enhancement technique according to the parameters only if the condition has been met.

18. An image enhancement system, comprising:
a means for reading image enhancement data from a memory integrated into a removable cartridge for an image forming device, the image enhancement data including a condition associated with a parameter for implementing an image enhancement technique; and
a means for implementing the image enhancement technique upon a determination that the condition has been met.

19. An image enhancement system, comprising:
a means for selecting an image enhancement data set from a plurality of image enhancement data sets contained in a memory integrated into a removable cartridge for an image forming device; and
a means for implementing an image enhancement technique identified by the selected image enhancement data set.
